(19) United States
(12) Patent Application Publication
(10) Pub. No.: US 2005/0027873 A1
(43) Pub. Date: Feb. 3, 2005

(54) Directing client requests in an information system using client-side information

(76) Inventors: Robert N. Mayo, Mountain View, CA (US); Parthasarathy Ranganathan, Palo Alto, CA (US); Robert J. Stets JR., Palo Alto, CA (US); Deborah A. Wallach, Emerald Hills, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/629,040

(22) Filed: Jul. 28, 2003

(51) Int. Cl. G06F 15/16

(52) U.S. Cl. 709/229

(57) ABSTRACT

An information system with mechanisms for directing incoming client requests to individual access subsystems based on client-side information associated with the client requests. The client-side information enables a client to direct the assignment of the client requests in a manner that enhances overall response time in the information system while minimizing loss of valuable cached information caused by power reduction in the information system.

### BACKGROUND

A wide variety of information systems may include persistent storage devices along with access subsystems for use in accessing the information held on the persistent storage devices. A data center, for example, may include large numbers of disk drives for persistent storage along with servers for accessing the information contained on the disk drives.

An access subsystem in an information system may function as a cache of information contained in persistent storage. For example, the main memories in the servers in a data center may be used as a cache of information contained on the data center disk drives. The caching of information may improve response time when handling access transactions.

A client of an information system may access the information system by providing client requests to the information system that target the information stored on the persistent storage devices of the information system. An information system having multiple access subsystems may include a mechanism for assigning the incoming client requests to individual access subsystems. For example, a data center may include a router that assigns incoming client requests to individual servers in a round-robin fashion.

It is often desirable to reduce the power consumption of an information system. In a data center, for example, it may be desirable to reduce power consumption during low use periods in order to reduce the costs of operating the data center. In addition, it may be desirable to reduce the power consumption to reduce heat in the data center environment. A reduction in heat in a data center may increase the reliability of hardware in a data center and may enable more density in data center hardware and avoid costs associated with over-provisioning in a data center.

The power consumption in an information system may be reduced by switching off individual access subsystems. In a data center, for example, power consumption may be reduced by switching off individual servers during low use periods. Unfortunately, the switching off of access subsystems in a prior information system that assigns incoming client requests to access subsystems in a round-robin fashion may cause the loss of valuable cached data and slow the overall response time in an information system.

### SUMMARY OF THE INVENTION

An information system is disclosed with mechanisms for directing incoming client requests to individual access subsystems based on client-side information associated with the client requests. The client-side information enables a client to direct the assignment of the client requests in a manner that enhances overall response time in the information system while minimizing loss of valuable cached information caused by power reduction in the information system. An information system according to the present teachings includes a set of access subsystems each for use in accessing a persistent store in the information system in response to a client request and further includes a transaction director that assigns the client request to the access subsystems in response to a set of client-side information associated with the client request.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows an information system according to the present teachings;

FIG. 2 shows another information system according to the present teachings;

FIG. 3 shows a data center that incorporates the present teachings;

FIG. 4 shows an information server according to the present teachings.

### DETAILED DESCRIPTION

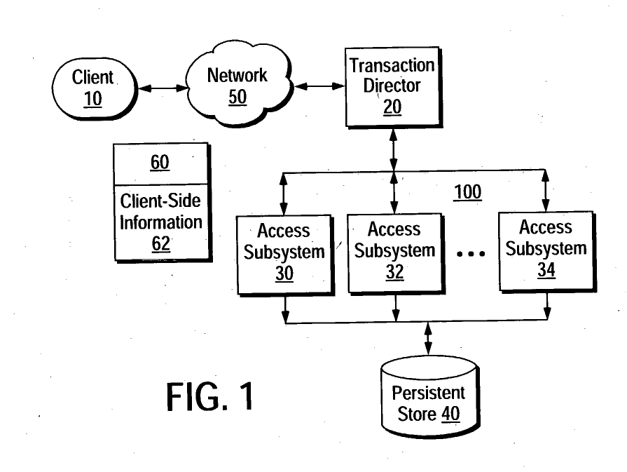

FIG. 1 shows an information system 100 according to the present teachings. The information system 100 includes a persistent store 40 and a mechanism for accessing the persistent store 40 that includes a set of access subsystems 30-34. The access subsystems 30-34 may be, for example, information servers or hardware/software subsystems within an information server, CPU subsystems in an information server, etc.

The information system 100 includes a transaction director 20 that obtains a client request 60 from a client 10 via a network 50. The client 10 may be a computer system with a web browser, e.g. desktop, notebook system, etc., or a handheld wireless device, or any device capable of web browsing. In other embodiment, the client 10 may issue client requests using other protocols that may be handled by the information system 100.

The client request 60 includes a set of client-side information 62. The client side information 62 may be information that is available to the client 10 and not available to the information system 100 but that may be useful in prioritizing the client request 60 or in determining the handling of the client request 60 in the information system 100. The transaction director 20 directs the client request 60 to the access subsystems 30-34 in response to the client-side information 62.

The client-side information 62 may include information pertaining to the properties of the client request 60. The client-side information 62 may include information pertaining to the client 10 or a user of the client 10. The client-side information 62 may include information pertaining to a history of prior interactions of the client 10 with the information system 100, e.g. database tables accessed in prior requests from the client 10 or functions performed, etc. This information may be maintained, for example, by an application program on the client 10.

The client-side information 62 may include an indication of the potential frequency of client requests associated with the client 10. If the client-side information 62 indicates a relatively low potential frequency then the transaction director 20 may assign the client request 60 to the access subsystems 30-34 that are allocated for lower frequency requests. Conversely, if the client-side information 62 indicates a relatively high potential frequency then the transaction director 20 may assign the client request 60 to the access subsystems 30-34 that are allocated for higher frequency requests.

The client-side information 62 may include an indication of the priority of the data targeted by the client request 60. If the client-side information 62 indicates a relatively high priority data then the transaction director 20 may assign the client request 60 to the access subsystems 30-34 that are allocated for higher priority data. Conversely, if the client-side information 62 indicates a relatively low priority data then the transaction director 20 may assign the client request 60 to the access subsystems 30-34 that are allocated for lower priority data.

The client-side information 62 may include hints on where data targeted by the client request 60 may be stored. A hint may pertain to the database tables stored on the persistent store 40 or to information that may be cached in the access subsystems 30-34. The transaction director 20 may assign the client request 60 to the access subsystems 30-34 in response to the hints.

The client-side information 62 may include a cost indication in a multi-layered cost structure that is associated with the client 10. The transaction director 20 may assign the client request 60 to the access subsystems 30-34 by matching the cost indication from the client-side information 62 to cost indications or ranks associated with the access subsystems 30-34.

The client-side information 62 may include an indication of computational intensity associated with performing the client request 60. If the client-side information 62 indicates a relatively high computational intensity then the transaction director 20 may assign the client request 60 to the access subsystems 30-34 that are allocated for high computation intensive tasks. Conversely, if the client-side information 62 indicates a relatively low computational intensity then the transaction director 20 may assign the client request 60 to the access subsystems 30-34 that are allocated for low computation intensive tasks.

The client-side information 62 may include samples from sensors in the environment of the client 10. The transaction director 20 may assign the client request 60 to the access subsystems 30-34 in response to the sensor samples.

The client-side information 62 may include an indication of the hardware capabilities associated with the client 10—for example communication capability, processing power, etc. The transaction director 20 may assign the client request 60 to the access subsystems 30-34 in response to the indicated capability. For example, client requests from low bandwidth wireless connections may be assigned to lower priority or lower ranking access subsystems 30-34.

The client-side information 62 may include an indication of the type of application in the client 10 that generated the client request 60. The transaction director 20 may assign the client request 60 to the access subsystems 30-34 in response to the indicated application. For example, the access subsystems 30-34 may be individually allocated for handling particular types of applications.

The client-side information 62 may include an indication of the location of the client 10. The location may be geographic or organizational. The transaction director 20 may assign the client request 60 to the access subsystems 30-34 in response to the indicated location.

The client-side information 62 may include a cookie that is stored in the client 10 and that when included in the client-side information 62 may be used to direct the handling of the client request 60 within the information system 100. For example, a cookie may be used to indicate a priority of the client request 60 or the importance of a user of the client 10 and direct the client request 60 to the access subsystems 30-34 that are provided for the indicated priority of requests and/or clients.

In one embodiment, each of the access subsystems 30-34 has a rank and the transaction director 20 assigns the client request 60 to the access subsystems 30-34 based on the ranks of the access subsystems 30-34 and the client-side information 62. The access subsystems 30-34 may be ranked in any manner. For example, if there are N of the access subsystems 30-34 then the access subsystem 30 may be assigned a rank=1 and the access subsystem 32 a rank=2, etc., or visa versa. Any numbering system or rank indicators may be used. More than one of the access subsystems 30-34 may be assigned the same rank and there may be any number of ranks assigned.

The client-side information 62 may include a priority metric or may map to a priority metric and the transaction director 20 may assign the client request 60 to the access subsystems 30-34 by matching the ranks of the access subsystems 30-34 to the priority metric in the client-side information 62.

The client-side information 62 may be binding such that the transaction director 20 may not opt to not use any client-side information provided in the client request 60. Alternatively, the client-side information 62 may be non-binding, thereby allowing the transaction director 20 to use other methods for assigning the access subsystems 30-34 to the client request 60—possibly using the client-side information 62 as a hint.

The client-side information 62 may be used to trigger changes in the power adaptation of the information system 100 based on programmed heuristics automatically or through manual intervention using the client-side information 62 as a hint or a combination of these factors.

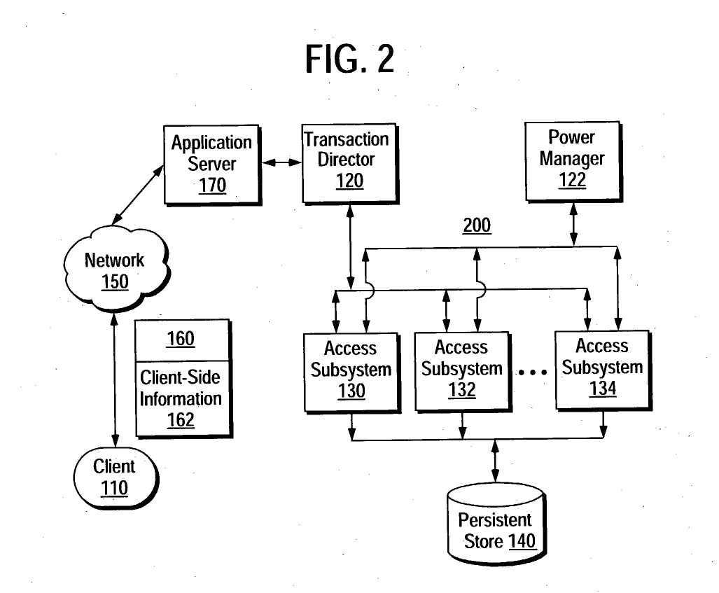

FIG. 2 shows an information system 200 according to the present teachings. The information system 200 includes a persistent store 140 and a mechanism for accessing the persistent store 140. The mechanism for accessing the persistent store connects to a set of access subsystems 130-134. The access subsystems 130-134 may be, for example, information servers or hardware/software subsystems within an information server. The power status of each access subsystems 130-134 is individually controllable.

The information system 200 includes a power manager 122 performs power adaptation by altering the power state of the access subsystems 130-134. For example, an excessive amount of power consumption or excessive heat may cause the power manager 122 to perform power adaptation by switching off one or more of the access subsystems 130-134 or by placing one or more of the access subsystems 130-134 in a reduced power state. Similarly, if the load of incoming client requests in the information system 200 is relatively low then the power manager 122 may perform power adaptation by switching off one or more of the access subsystems 130-134 or by placing one or more of the access subsystems 130-134 in a reduced power state in order to conserve power. In another example, if the load of incoming client requests is relatively high then the power manager 122 may perform power adaptation by switching on one or more of the access subsystems 130-134 that are in a power off state. Similarly, if the load of incoming client requests is relatively high then the power manager 122 or some other element of the information system 200 may perform power adaptation by removing the power reduction state of one or-more of the access subsystems 130-134 that are in a reduced power state. The power manager 122 may measure response time to client requests so that an increase in response time may trigger power adaptation.

The above provide a few examples of conditions that may trigger power adaptation automatically using programmed heuristics. A variety of other conditions may cause the power manager 122 to trigger power adaptation. In addition, the power adaptations in the information system 200 may be triggered manually through the intervention of a system administrator. For example, the power manager 122 may generate one or more web pages that enable manual power control using web protocols via a network 150 or an internal network in the information system 200.

Each of the access subsystems 130-134 is assigned a rank for use in power adaptation in the information system 200. The power manager 122 selects the access subsystems 130-134 to be powered down or to be placed in a power reduction state on the basis of their assigned rank. For example, the power manager 122 initially powers down the access subsystem 130-134 having the lowest rank that is currently in a full power state and then powers down the access subsystem 130-134 having the next lowest rank that is currently in a full power state, etc., as needed to accomplish the appropriate power adaptation.

In addition, the power manager 122 selects the access subsystems 130-134 that are to be restored to a full power state on the basis of their assigned rank. For example, the power manager 122 initially restores to full power the access subsystem 130-134 having the highest rank that is currently in an off state or a reduced power state and then powers up the access subsystem 130-134 having the next highest rank that is currently in an off or reduced power state, etc., as needed to accomplish the appropriate power adaptation.

The information system 200 includes an application server 170 that obtains a client request 160 from a client 110 via the network 150 and that generates one or more access transactions in response to the client request 160. For example, the client request 160 may be an HTTP request and the resulting access transactions may be SQL transactions that target the persistent store 140.

The information system 200 includes a transaction director 120 that assigns that access transactions caused by the client request 160 to the access subsystems 130-134 in response to a set of client-side information 162 carried in the client request 160. The client-side information 62 may provide a priority metric that maps to the ranking of the access subsystems 130-134. For example, if the access subsystems 130-134 are ranked from 1 to N then a priority metric may be between 1 and N. In such an embodiment, an access transaction corresponding to a priority metric=1 will be handled by the access subsystem 130-134 having a rank=1 and an access transaction corresponding to a priority metric=2 will be handled by the access subsystem 130-134 having a rank=2, etc. Alternatively, any type of mapping between ranks of the access subsystems 130-134 and the client-side information may be used.

If a matching low ranking access subsystem 130-134 is not active when an access transaction having a low priority metric is to be assigned then the transaction director 120 assigns the lowest ranking active access subsystem 130-134. In the example 1-N ranking and priority metrics, when the access subsystem 130-134 having a rank=1 is not active an access transaction having a priority metric=1 will be handled by the access subsystem 130-134 having a rank=2 if it is active or by the access subsystem 130-134 having a rank=3 if it is active, etc.

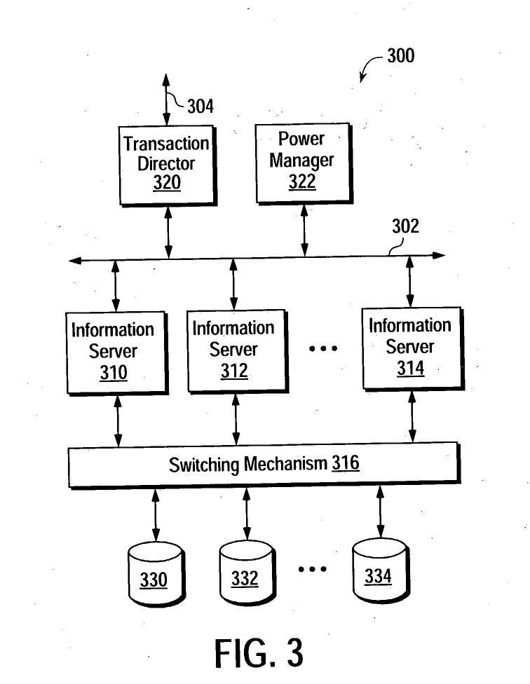

FIG. 3 shows a data center 300 that incorporates the present teachings. The data center 300 includes a set of storage devices 330-334, a set of information servers 310-314, a transaction director 320, and a power manager 322. The data center 300 includes a switching mechanism 316 that enables access to all of the storage devices 330-334 from all of the information servers 310-314.

The storage devices 330-334 provide large scale persistent storage of data for applications implemented in the data center 300. In a database application, for example, the storage devices 330-234 provide a persistent store for database tables and records, etc.

The transaction director 320 obtains incoming access transactions via a communication path 304 and assigns each incoming access transaction to the information servers 310-314 in response to the corresponding client-side information and the ranks of the information servers 310-314. The transaction director 320 distributes the access transactions to the information servers 310-314 via an internal network 302.

The information servers 310-314 perform reads from and/or writes to the storage devices 330-334 via the switching mechanism 316 to access persistent data as needed when carrying out the access transactions. Each of the information servers 310-314 includes an internal non-persistent memory, for example random access main memory, that is used as a cache for holding subsets of the data that is held persistently on the storage devices 330-334.

The power manager 322 monitors power consumption and/or environmental and/or incoming access transaction load and/or other conditions in the data center 300 and performs power adaptation when appropriate. The power adaptations by the power manager 322 may also be triggered manually.

The present techniques may increase the likelihood that data for high priority access requests will be cached in the active information servers 310-314 because the information servers 310-314 that handle lower priority access transactions are powered down first. This may minimize the performance degradation that might otherwise occur when servers are powered down without regard to their rank or the nature of the access transactions that they handle.

The transaction director 320 and/or power manager 322 may be implemented as code on a node having computing resources and communication resources.

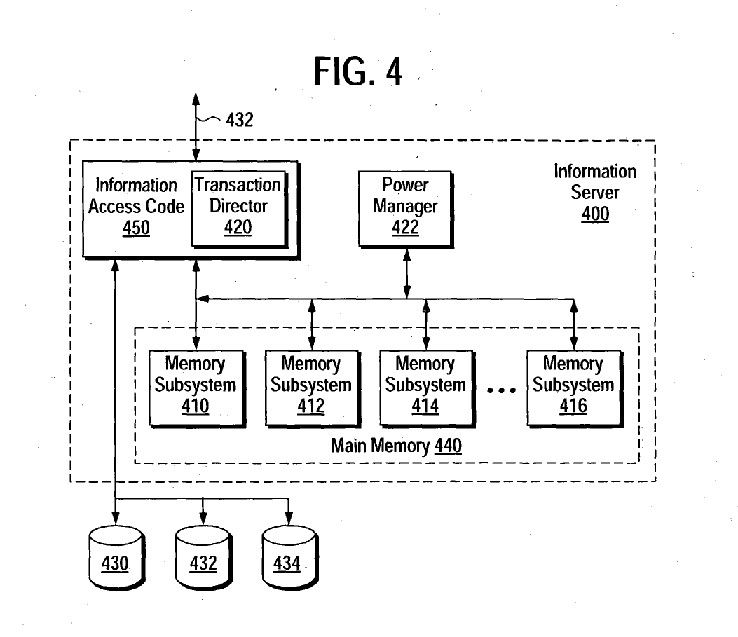

FIG. 4 shows an information server 400 according to the present teachings. The information server 400 enables access to data that is stored in a set of persistent storage devices 430-434. The information server 400 includes a main memory 440, a set of information access code 450 that includes a transaction director 420, and a power manager 422.

The information access code 450 obtains access transactions via a communication path 432. The information access code 450 performs read/write accesses to the persistent storage devices 430-434 as needed to service the received access transactions.

The information access code 450 uses the main memory 440 as a cache for information stored in the persistent storage devices 430-434. The main memory 440 is subdivided into a set of memory subsystems 410-416. The power status of each of the memory subsystems 410-416 is independently controllable by the power manager 422. For example, the power manager 422 may independently switch on/off each of the memory subsystems 410-416 or place each of the memory subsystems 410-416 in power reduction mode or remove each of the memory subsystems 410-416 from a power reduction mode. In one embodiment, the main memory 440 is comprised of random access memories that are arranged into banks wherein the power state of each bank is individually controllable.

Each memory subsystems 410-416 has a rank for use in power adaptation in the information server 400. The power manager 422 monitors the power consumption of the information server 400, load conditions, and/or environmental and/or other conditions associated with the information server 400 and performs power adaptation when appropriate. The power manager 422 selects the memory subsystems 410-416 to be powered down or to be placed in a power reduction state on the basis of their assigned rank. In addition, the power manager 422 selects the memory subsystems 410-416 that are to be restored to a full power state on the basis of their assigned rank.

The transaction director 420 individually assigns the memory subsystems 410-416 to cache data associated with the access transactions received via the communication path 432 in response to client side information associated with the access transactions and the ranks of the memory subsystems 410-416. For example, the memory subsystems 410-416 having a high rank may be selected for the access transactions having a high priority indicated in their client-side information and the memory subsystems 410-416 having a low rank may be selected for the access transactions having a low priority indicated in their client-side information.

The present techniques may increase the likelihood that data for high priority access transactions will be cached in active memory subsystems because the memory subsystems 410-416 that handle lower priority transactions are powered down first. This minimizes the performance degradation that might otherwise occur if the memory subsystems 410-416 were to be powered down without regard to their rank, i.e. the priority of access transactions whose data they cache.

The foregoing detailed description of the present invention is provided for the purposes of illustration and is not intended to be exhaustive or to limit the invention to the precise embodiment disclosed. Accordingly, the scope of the present invention is defined by the appended claims.

1. An information system, comprising:
a set of access subsystems each for use in accessing a persistent store in the information system in response to a client request;
transaction director that directs the client request to the access subsystems in response to a set of client-side information associated with the client request.

2. The information system of claim 1, wherein the client-side information includes a set of information pertaining to a client that generated the client request.

3. The information system of claim 1, wherein the client-side information includes a set of information pertaining to a user that caused the client request.

4. The information system of claim 1, wherein the client-side information includes information pertaining to a history of prior interactions with the information system.

5. The information system of claim 1, wherein the client-side information includes a potential frequency of client requests from a client that generated the client request.

6. The information system of claim 1, wherein the client-side information includes a priority of a set of data targeted by the client request.

7. The information system of claim 1, wherein the client-side information includes a hint on where a set of data targeted by the client request may be stored.

8. The information system of claim 1, wherein the client-side information includes a cost indication with the client request.

9. The information system of claim 1, wherein the client-side information includes a computational intensity associated with the client request.

10. The information system of claim 1, wherein the client-side information includes a set of samples from sensors in an environment of a client that originated the client request.

11. The information system of claim 1, wherein the client-side information includes an indication of hardware capabilities of a client that originated the client request.

12. The information system of claim 1, wherein the client-side information includes an indication of a type of application that generated the client request.

13. The information system of claim 1, wherein the client-side information includes an indication of a location of a client that originated the client request.

14. The information system of claim 1, wherein the client-side information includes a cookie that is stored in a client that originated the client request.

15. The information system of claim 1, wherein the transaction director assigns the client request to the access subsystems in response to the client-side information and a rank associated with each access subsystem.

16. A method for directing a client request in an information system by assigning the client request to an access subsystem in the information system in response to a set of client-side information associated with the client request.

17. The method of claim 16, wherein the client-side information includes a set of information pertaining to a client that generated the client request.

18. The method of claim 16, wherein the client-side information includes a set of information pertaining to a user that caused the client request.

19. The method of claim 16, wherein the client-side information includes information pertaining to a history of prior interactions with the information system.

20. The method of claim 16, wherein the client-side information includes a potential frequency of client requests from a client that generated the client request.

21. The method of claim 16, wherein the client-side information includes a priority of a set of data targeted by the client request.

22. The method of claim 16, wherein the client-side information includes a hint on where a set of data targeted by the client request may be stored.

23. The method of claim 16, wherein the client-side information includes a cost indication with the client request.

24. The method of claim 16, wherein the client-side information includes a computational intensity associated with the client request.

25. The method of claim 16, wherein the client-side information includes a set of samples from sensors in an environment of a client that originated the client request.

26. The method of claim 16, wherein the client-side information includes an indication of hardware capabilities of a client that originated the client request.

27. The method of claim 16, wherein the client-side information includes an indication of a type of application that generated the client request.

28. The method of claim 16, wherein the client-side information includes an indication of a location of a client that originated the client request.

29. The method of claim 16, wherein the client-side information includes a cookie that is stored in a client that originated the client request.

30. The method of claim 16, wherein the step of assigning includes the step of assigning the client request to the access subsystems in response to the client-side information and a rank associated with each access subsystem.
